(19) United States
(12) Patent Application Publication
(10) Pub. No.: US 2024/0062609 A1
(43) Pub. Date: Feb. 22, 2024

(54) PARKING METER HOUSING FOR FACILITATING MAINTENANCE

(71) Applicant: J.J. MACKAY CANADA LIMITED, New Glasgow (CA)

(72) Inventors: James George MacKay, Frasers Mountain (CA); Adrian Ignatius O’NEIL, New Glasgow (CA); Darren Scott CAMERON, New Glasgow (CA)

(21) Appl. No.: 18/235,667

(22) Filed: Aug. 18, 2023

(30) Foreign Application Priority Data
Aug. 18, 2022 (CA) 3170736

(51) Int. Cl. G07F 17/24

(52) U.S. Cl. CPC G07F 17/248

(57) ABSTRACT

A parking meter housing may be provided as a first housing secured or fixed at the parking meter location and a second separable housing that can be locked to the first housing. The second housing can have a number of parking meter components mounted to it. The first and second housings have cooperating features that allow the second housing, once it is at least partially separated from the first housing, to be supported by the first housing in a position that facilitates performing maintenance on the parking meter components.

### TECHNICAL FIELD

The current disclosure relates to parking meters, and in particular to the housing assemblies of parking meters.

### BACKGROUND

Parking meters comprise various components used in metering the time for parking spaces. These components may include payment devices such as coin chutes and card readers, processors and/or microcontrollers, batteries, etc. These components are secured within an exterior housing to provide protection to the components from the environment as well as possible vandalism.

It is necessary to perform maintenance on these components from time to time. In order to perform maintenance, maintenance personnel may open the housing, remove a parking meter mechanism from the housing that has the parking meter components and replace the mechanism with a functioning one. Alternatively, the parking meter mechanism may be taken to a nearby location, such as a maintenance vehicle, to perform the required maintenance, which may include replacing components, fixing components etc.

Alternatively, repair of the parking meter may be attempted on site at the installation location while the meter has been removed from the meter housing. This on-site repair task can be challenging and awkward because the repair technician is required to hold the meter with one hand while using his/her other free hand to attempt to effect the necessary repair or component replacement.

Performing maintenance on parking meters, including parking meter mechanisms and corresponding metering components, can be difficult and/or time consuming. As parking meters are typically located in areas that are inconvenient for performing maintenance, this can add to the difficulty and/or time consuming nature of the maintenance.

### SUMMARY

In accordance with the present disclosure there is provided a single space parking meter comprising: parking meter components providing metering functionality for a parking space; and a housing comprising a first portion secured to a mounting structure located in the vicinity of the parking space and a second portion having one or more of the parking meter components coupled to an interior side of the second portion of the housing, the second portion at least partially separable from the first portion of the housing, wherein: in a secured orientation of the housing, the first portion and the second portion of the housing are mounted to the mounting structure and provide protection to the parking meter components from an external environment; and in a maintenance orientation of the housing, the second portion of the housing is mounted to the first portion of the housing to provide access to the parking meter components to facilitate performing maintenance on one or more of the parking meter components.

In a further embodiment of the single space parking meter, the second portion of the housing comprises at least one bracket extending from a bottom of the second portion of the housing that engages with a cooperating bracket feature of the first portion of the housing.

In a further embodiment of the single space parking meter, the second portion of the housing comprises a pair of brackets that slidably engage with corresponding bracket features of the first portion of the housing to hold the second portion of the housing in a substantially horizontal orientation.

In a further embodiment of the single space parking meter, the pair of brackets are received within corresponding recesses in the parking meter in the secured orientation.

In a further embodiment of the single space parking meter, the corresponding recesses are at least partially within the mounting structure of the parking meter.

In a further embodiment of the single space parking meter, the bracket of the second portion of the housing is one of: a separate component that is secured to the second portion of the housing; and formed as an integral component of the second portion of the housing.

In a further embodiment of the single space parking meter, the accessible parking meter components are arranged substantially horizontally when the housing is in the maintenance orientation.

In a further embodiment of the single space parking meter, the housing can be placed in a second maintenance position with the accessible parking meter components arranged substantially vertically.

In a further embodiment of the single space parking meter, the first portion of the housing is secured to the mounting structure in both the secured orientation and the maintenance orientation.

In a further embodiment of the single space parking meter, the second portion of the housing is locked to the first portion of the housing in the secured orientation.

In a further embodiment of the single space parking meter, a keyed lock is accessible through the first portion of the housing.

In accordance with the present disclosure there is further provided a single space parking meter comprising: parking meter components providing metering functionality for a parking space; and a housing comprising a first portion secured to a mounting structure located in the vicinity of the parking space and a second portion having one or more of the parking meter components coupled to an interior side of the second portion of the housing, the second portion at least partially separable from the first portion of the housing, wherein the first portion and the second portion can be arranged in: a vertical maintenance position in which the second portion is secured to the first portion in a generally vertical orientation with at least a portion of the parking meter components accessible for performing maintenance; and a horizontal maintenance position in which the second portion is secured to the first portion in a generally horizontal orientation with one or more of the parking meter components accessible for performing maintenance.

### BRIEF DESCRIPTION OF THE DRAWINGS

Further features and advantages of the present disclosure will become apparent from the following detailed description, taken in combination with the appended drawings, in which:

FIG. 1 depicts an illustrative parking meter with the housing in a secured orientation;

FIG. 2 depicts the parking meter with the housing in a maintenance orientation;

FIG. 3 depicts a side view of the parking meter with the housing in a maintenance orientation;

FIG. 4 depicts a top view of the parking meter with the housing in the maintenance orientation;

FIG. 5 depicts a detailed view of the parking meter with the housing in the maintenance orientation;

FIG. 6 depicts an illustrative mounting bracket used to secure the housing in the maintenance orientation;

FIG. 7 depicts a detailed view of the mounting bracket mounted to an interior structure; and

FIG. 8 depicts a mounting plate for use with the mounting bracket.

### DETAILED DESCRIPTION

Parking meters are typically deployed around cities to meter parking spaces. The parking meters may be used to meter one or more parking spaces and may be broadly categorized as single space parking meters or multi space parking meters. It will be appreciated that the terms single space and multi space are used more to describe the physical meter as opposed to its functionality. Single space parking meters are typically smaller units with a plurality of them mounted to poles located in close proximity to the parking spaces being metered. Multi space meters are typically larger cabinets with a single unit being used to meter a larger number of parking spaces, such as the parking spaces for a street block.

Parking meters have a number of components used to provide the metering functionality with the components secured within a protective housing. The components may include, for example, electronics such as processors, microcontrollers, FPGAs, ASICs, associated memories, communication radios, batteries, solar panels, and power circuitry. The components may further include one or more user interfacing components such as displays, LEDs, etc., and one or more user controls such as buttons, switches, keyboards, etc. As well, the components may include payment devices such as coin chutes/discriminators, magnetic card readers, smart card readers, and/or NFC payment readers. The parking meter components are secured within an exterior housing of the parking meter that provides protection to the components from the environment as well as from vandalism and/or theft.

Maintenance may need to be performed from time to time on the parking meter. The maintenance may include inspecting components to identify potential problems before they occur, as well as repairing or replacing broken components. Other common maintenance tasks may include fixing acts of vandalism such as removing jams from a coin chute or card slot.

Performing maintenance on the parking meter can require opening the housing to gain access to parking meter components. As described further herein, the parking meter may have a housing that includes features that allow a portion of the parking meter to be at least partially detached or separated from the other portion of the parking meter and then mounted to the other portion of the meter that remains secured at the parking space in an orientation that allows the components to be worked on. The housing features provide an easy and convenient way to secure the at least partially detached or separated portion of the parking meter in a position for maintenance personnel to more easily work on the parking meter with both hands and without having to move to a different location. In addition to providing an easy and convenient way of securing the parking meter in a manner to facilitate performing maintenance, the solution described herein may be provided with no, or relatively few, moving parts and as such provides a simple, cost-effective solution. The solution may have other benefits which include increasing the meter's overall strength and resistance to vandal attacks.

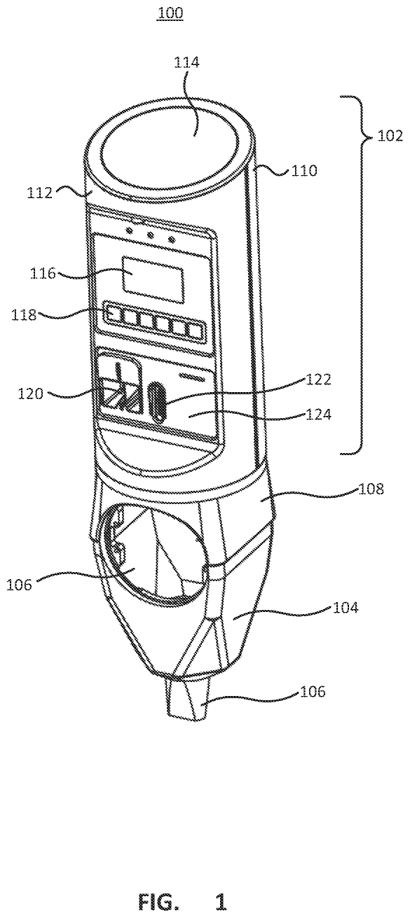

FIG. 1 depicts an illustrative parking meter with the housing in a secured orientation. The parking meter 100 is depicted as a single space parking meter, although it may provide functionality for metering a number of parking spaces. The parking meter 100 comprises a meter mechanism 102 that is secured to a coin vault 104. The coin vault is secured to a pole 106 or other structure at the parking meter's location. Parking meter mechanisms 102 can be replaced independent of the coin vaults that can remain in place at the parking meter locations. A lower surface of the parking meter mechanism mates to an upper surface of the coin vault, and as such the two surfaces should have the same shape or corresponding shapes. However, in order to provide greater flexibility in the design of the parking meter mechanism, a saddle plate or adapter plate 108 may be used to adapt the shape of the upper surface of the coin vault 104 to the lower surface of the parking meter mechanism 102. For example, the saddle plate 108 may adapt the generally rectangular shape of the upper surface of the coin vault to the generally circular shape of the lower surface of the parking meter mechanism.

The parking meter mechanism 102 may comprise various components that are enclosed within a housing that can be secured to the coin vault, either directly, or through the saddle plate. The housing may comprise one or more housings that can be connected together. For example, in the parking meter 100 the external housing is provided by a rear housing 110 and a front housing 112. The front housing 112 may have one or more features extend over the rear housing 110 in order to hide, and possibly protect, the connection between the front housing and the rear housing. Although other arrangements for securing the meter mechanism to the coin vault are possible, the rear housing 110 may be secured to the coin vault/saddle plate for example by bolts or other connection means and then the front housing 112 may be secured and locked in place to the rear housing 110. Such an arrangement allows the front housing 112 to be unlocked and detached from the rear housing 110, which may remain secured in place on the coin vault. Although not visible in the figures, the rear housing, or the front housing, may provide access to a keyed lock that is used to secure and lock the front housing and the rear housing together, and possibly lock the parking meter mechanism to the coin vault. The access to the keyed lock may be protected by a moveable door or cover. The door or cover may be moved using a magnet in order to hide from casual vandals how the key is accessed. This may be particularly well suited for use in cases where the rear housing is made of a non-magnetic material such as austenitic stainless steel.

The front housing 112 may have a number of parking meter components mounted to it, either directly or through one or more intermediate structures. For example, the front housing 112 may include a solar panel 114 that can provide power to the parking meter. Additional components mounted to the front housing 112 may include output components such as one or more displays 116 and LEDs for displaying information to users, and input components such as keys 118, buttons, switches, etc. It will be appreciated that the output components and input components may be combined together such as in a touch screen display. Further components may include payment components such as a card reader 120 that may allow a magnetic strip card to be inserted and read, and a coin chute/discriminator 122 into which coins can be inserted and deposited into the coin vault. The payment devices may also include one or more non-contact payment devices that can be read by ‘tapping’ a payment device at a particular location, such as location 124, on the front housing. The particular location for tapping non-contact payment devices will depend upon the location of reading antennas which can be located in various locations within the parking meter. Electronics operating the parking meter such as processors, microcontrollers, memories, batteries, cellular and Wi-Fi communication radios may be mounted within the housing, such as either mounted to the front housing such that they are externally exposed when the front housing is separated from the rear housing, or to the rear housing.

FIG. 1 depicts the housing with the front housing 112 in a secured orientation in which it is secured to the rear housing 110. In this secured orientation, the front housing may be locked to the rear housing 110 and the coin vault 104. The front housing 112 may be detached or separated from the rear housing and then re-mounted to the rear housing in a maintenance orientation in order to allow maintenance to be performed on one or more of the parking meter components. Additionally, the front housing may have shaped aspects or features which in the locked and secured position at least partially extend over portions of the rear housing where the rear housing mates with and is secured to the front housing, thereby making it less obvious to the vandals or any casual observer as to the attachment location and means to secure the front and rear housing together.

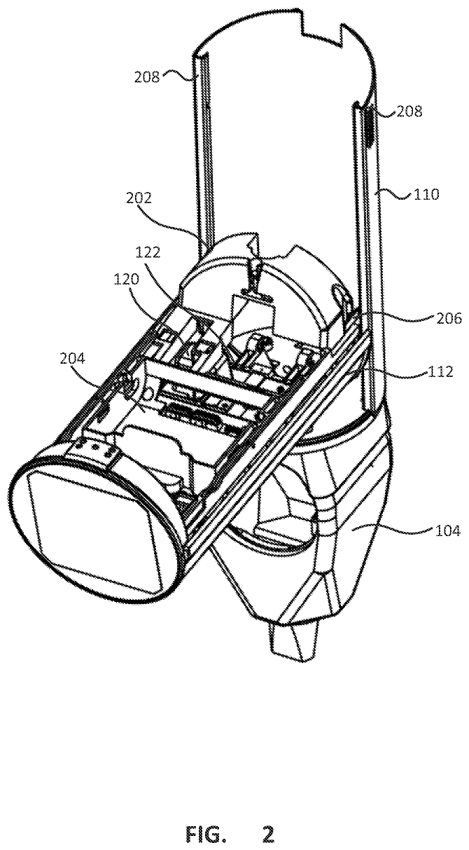

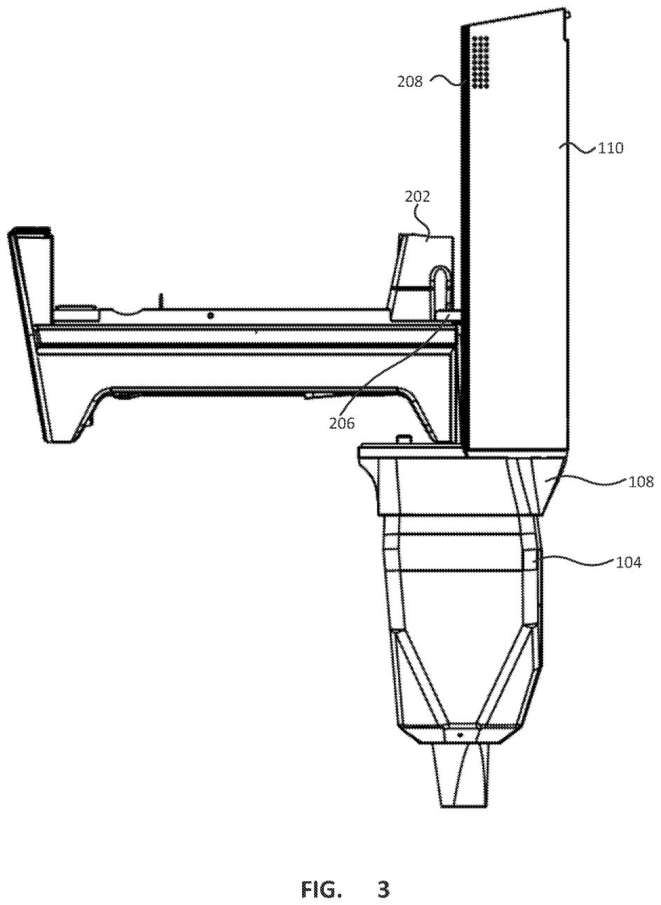

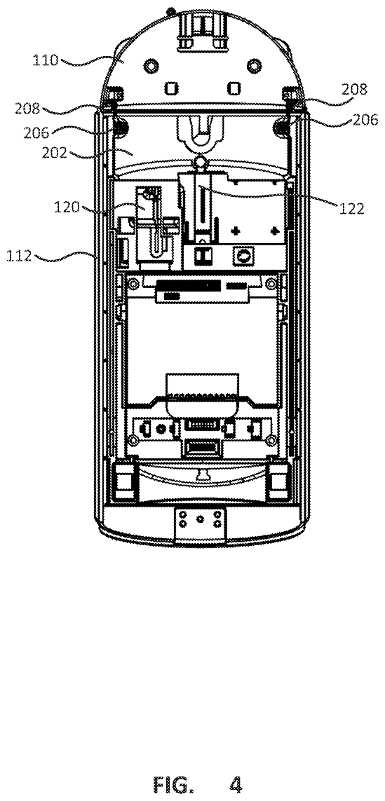

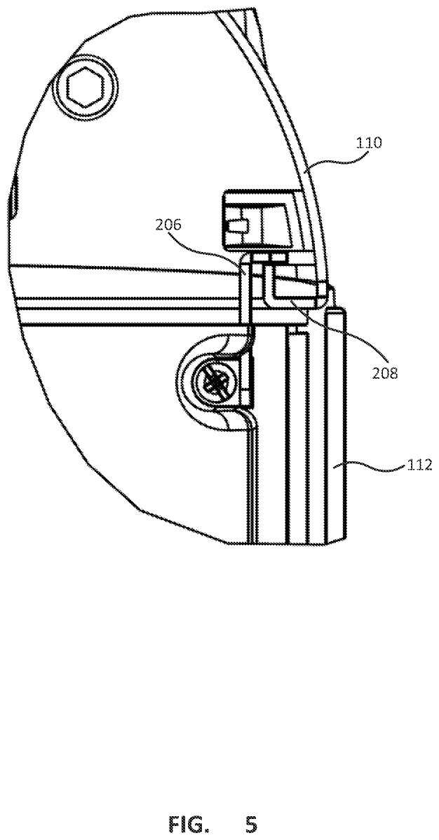

The parking meter with the front housing mounted in a maintenance orientation is depicted in FIGS. 2 to 5. FIG. 2 depicts the parking meter with the housing in the maintenance orientation. FIG. 3 depicts a side view of the parking meter with the housing in the maintenance orientation. FIG. 4 depicts a top view of the parking meter with the housing in the maintenance orientation. FIG. 5 depicts a detailed view of the parking meter with the housing in the maintenance orientation. As depicted most clearly in FIGS. 2 and 3, with the front housing 112 mounted in the maintenance orientation, the interior side of the front housing is arranged approximately horizontally and provides access to the interior components mounted to the front housing. With the front housing mounted in the maintenance orientation, maintenance personnel are able to use one or both hands to easily perform required maintenance on the exposed components, including for example examining the components, replacing components, repairing components, removing jams, etc. While FIG. 3 shows the front housing at the lowest possible horizontal maintenance position, it is possible for the front housing to be positioned at any other position relative to the rear housing when the maintenance bracket is engaged with the rear housing rails. Additionally or alternatively, it is possible for the front meter housing to be placed into at least two fixed vertical maintenance positions while in the unlocked position when lifted vertically but still engaged on the rails of the rear cover. That is, the front cover may have one or more elements that can releasably engage with corresponding features on the rails on which the front cover is slid vertically up and down. As the front cover, and attached parking meter components, are slid vertically on the rails, vertical locking elements can engage and hold the cover in the vertical position in which a portion of the interior of the parking meter may be accessible in order to observe, work on and/or replace parking meter components. Accordingly, a parking meter may include both vertical locking elements that secure the parking meter, or more particularly the front cover, in a vertical maintenance position and the maintenance bracket which can allow the front cover to be secured in a horizontal maintenance position. The vertical and horizontal maintenance positions can provide flexibility to maintenance workers working on the parking meter in the field, allowing the maintenance worker to orient, and secure the parking meter in an orientation that is convenient and comfortable for the individual maintenance worker.

The parking meter components may be mounted to an interior side of the front housing, either directly or indirectly. For example an interior structure 202 may be mounted to the front housing 112 and one more of the parking meter components may be mounted to the interior structure 202. For example, the card reader 120 and coin chute 122 may be mounted to respective locations on the interior structure 202. Additional components may be connected to the front housing or interior structure. For example, a rechargeable battery 204 may be received within the housing along with other electronic components not shown in the figures, such as controllers, communication radios, etc.

The front housing 112 has one or more features that allow the front housing to be mounted in the maintenance orientation. The features include a pair of mounting support brackets 206 located on either side of a bottom of the front housing. The brackets 206 which can be affixed to the bottom of the front housing, such as in a rigid manner, each have a leg that extends from the bottom of the front housing and can engage on rails 208 or similar structures located on the rear housing 110.

The front housing may be mounted in the maintenance orientation by first at least partially detaching or separating the front housing from the rear housing and then orienting the front housing approximately horizontally so that the brackets 206 can be placed over the top of the rails 208. The front housing can then be slid down the rails 208 and the brackets 206 can support the front housing in the maintenance orientation. The front housing may be slid down the rails to a suitable position for performing maintenance. Once in the desired position, the cover can be released and the brackets 206 engage the rails 208 to support the front housing in the desired position. Additionally, the front housing may slide down the rails to a position that has the exterior side of the front housing resting against, adjacent to or in the vicinity of the bottom of the rear housing or the coin vault/saddle plate. The brackets 206 may engage on the rails 208 to support the front housing when in this maintenance orientation position. It will be appreciated that the front housing may be supported in other positions when in the maintenance orientation. Rather than sliding the front housing down the rails, the front housing may be oriented approximately horizontally and rotated so that the brackets 206 are oriented vertically allowing them to be slid past the rails and the cover then rotated back so that the brackets engage with the rails.

Although not depicted in the figures, the brackets and rails may engage with each other in other ways. For example, the rails 208 or other mounting structures on the rear housing may have openings or cutouts that receive and support corresponding features of the brackets.

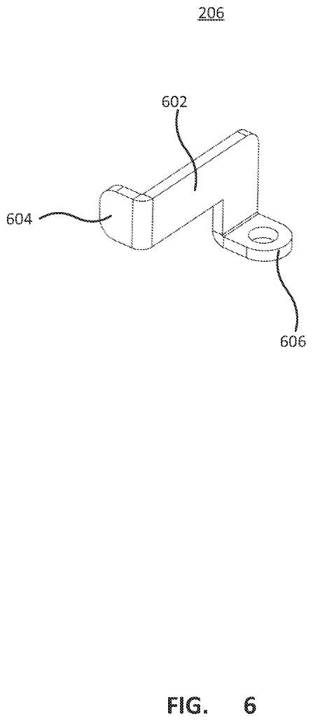

The brackets 206 and rails 208 may be made from the same or different material. The brackets 206 and/or rails may be made from metal, plastic or composites. As depicted most clearly in FIG. 5 and FIG. 6, the brackets 206 may be a separate component that can be secured to the front housing 112, for example, using screws, bolts or other fasteners. Alternatively, the brackets may be formed integrally with the front housing. Similarly, the rails 208 may be formed as separate components that are secured to the rear housing 110, or they may be formed as an integral component of the rear housing.

As depicted most clearly in FIG. 6, the bracket 206 may have a general “L” shape with the longer leg 602 extending away from the bottom surface of the front housing. A short leg 604 extends away from the long leg 602 generally perpendicularly. The short leg 604 can capture the rail or other corresponding feature on the rear housing to secure the front housing in the maintenance orientation. The bracket includes a mounting point 606 that allows the bracket 206 to be fastened to the front housing, such as in a rigid manner.

The bracket 206 may be considered as a male portion of a connection that engages with a corresponding female portion of the connection, which may be provided by the rail. In the parking meter described above, the male portion of the connection, namely, the bracket, is located on the front housing while the female portion of the connection, namely, the rail, is located on the rear housing. It is possible for the connection to be reversed so that a female portion of the connection is located on the front housing while the corresponding male portion is located on the rear housing.

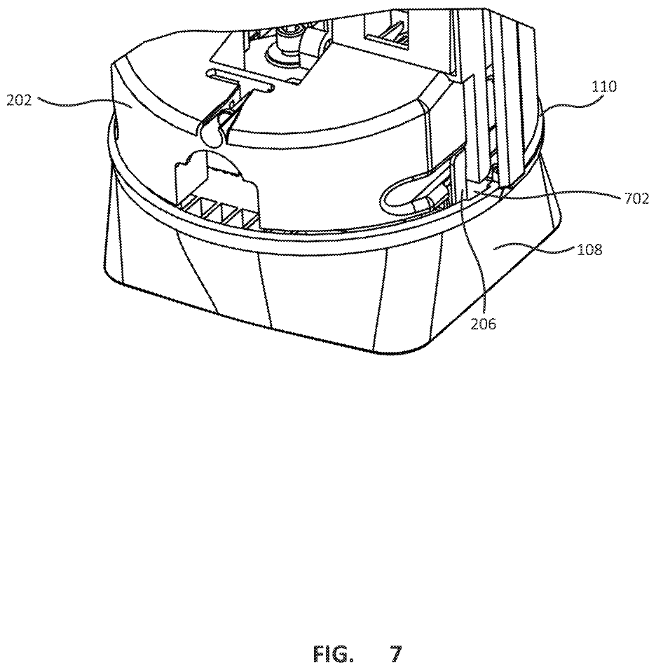

FIG. 7 depicts a detailed view of the mounting bracket mounted to interior structure 202, which is mounted to front housing 112. The parking meter depicted in FIG. 7 has the rear housing 110 removed to more clearly show the bracket 206. In FIG. 7, the front housing 112 is being placed into the secured orientation, although it has not been fully seated on the coin vault/saddle plate. As can be seen in FIG. 7, the bracket 206 extends below the bottom surface of the front housing and as such the coin vault and/or saddle plate has a recessed portion 702 that can receive the bracket 206 once the front housing is fully seated and in the secured orientation.

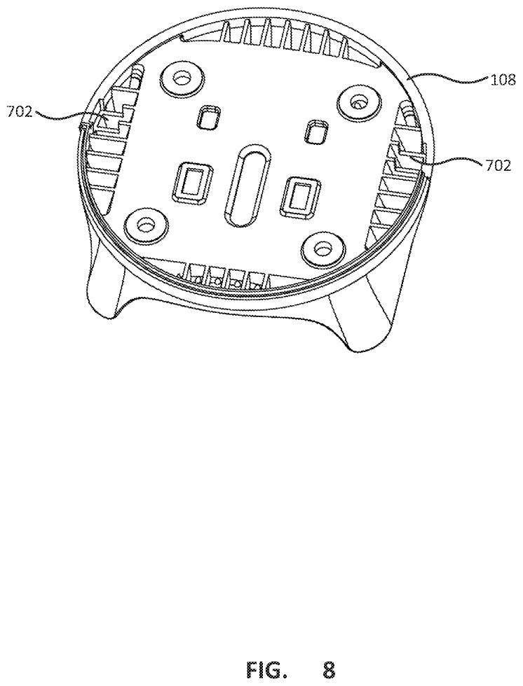

FIG. 8 depicts a saddle plate for use with the mounting bracket. As can be seen in FIG. 8, the saddle plate 108 may have a recess or pocket 702 cut or otherwise formed in the plate in order to provide enough room for the brackets to be received when the front housing is in the secured orientation. The bracket does not need to engage with other features when the housing is in the secured orientation and as such the recess or pocket 702 does not need corresponding features for engaging with the bracket. It is possible for the recess or pocket 702 to be sized such that the bracket can fit snugly into the recess or pocket. A snug fit can provide the meter with additional security and resistance against prying vandal attacks that attempt to move the base of the front housing in any horizontal direction. The snug fit and placement of the bracket into the recess or pocket 702 of the saddle plate 108 which is bolted to the vault housing together with the rear housing will further restrict movement of the front cover in any horizontal direction when the front housing is placed into the locked and secured position. Although depicted as a separate component, it is possible for the saddle plate, including the bracket recesses or pocket, to be formed as part of the parking meter such as the rear housing.

Although the recess or pocket does not require any additional engaging components to engage with the brackets in the secured position, it is possible to include one or more engaging components that can provide an additional locking mechanism for further securing the housing and parking meter to the coin vault. The additional engaging components may comprise one or more sliding bars or arms that may possibly be engaged with a spring mechanism or operated by the lock. Similarly, the lock may disengage the engaging components from the brackets and allow the front housing to be removed.

In addition, it is possible that the maintenance brackets could also be used in securing the front housing to the rear housing in the secured orientation. In such an implementation, the coin vault and/or saddle plate would require a corresponding feature that can be engaged by the bracket to secure the front housing in place.

Although various individual features and/or functionality may have been described with reference to a specific embodiment, such features and/or functionality may be incorporated into other embodiments. Similarly, the specific features and shapes described as providing particular functionality may be altered while still providing the required functionality.

Although specific embodiments of a parking meter are described, it will be appreciated that other parking meter designs, including other parking meter components or configurations of parking meter components, may incorporate the easy-maintenance housing described herein. Variations and modifications not described herein will be apparent to one of ordinary skill in the art having regard to the description herein.

What is claimed is:

1. A single space parking meter comprising:
parking meter components providing metering functionality for a parking space; and
a housing comprising a first portion secured to a mounting structure located in the vicinity of the parking space and a second portion having one or more of the parking meter components coupled to an interior side of the second portion of the housing, the second portion at least partially separable from the first portion of the housing, wherein:
in a secured orientation of the housing, the first portion and the second portion of the housing are mounted to the mounting structure and provide protection to the parking meter components from an external environment; and
in a maintenance orientation of the housing, the second portion of the housing is mounted to the first portion of the housing to provide access to the parking meter components to facilitate performing maintenance on one or more of the parking meter components.

2. The single space parking meter of claim 1, wherein the second portion of the housing comprises at least one bracket extending from a bottom of the second portion of the housing that engages with a cooperating bracket feature of the first portion of the housing.

3. The single space parking meter of claim 2, wherein the second portion of the housing comprises a pair of brackets that slidably engage with corresponding bracket features of the first portion of the housing to hold the second portion of the housing in a substantially horizontal orientation.

4. The single space parking meter of claim 3, wherein the pair of brackets are received within corresponding recesses in the parking meter in the secured orientation.

5. The single space parking meter of claim 4, wherein the corresponding recesses are at least partially within the mounting structure of the parking meter.

6. The single space parking meter of claim 2, wherein the bracket of the second portion of the housing is one of:
a separate component that is secured to the second portion of the housing; and
formed as an integral component of the second portion of the housing.

7. The single space parking meter of claim 1, wherein the accessible parking meter components are arranged substantially horizontally when the housing is in the maintenance orientation.

8. The single space parking meter of claim 7, wherein the housing can be placed in a second maintenance position with the accessible parking meter components arranged substantially vertically.

9. The single space parking meter of claim 1, wherein the first portion of the housing is secured to the mounting structure in both the secured orientation and the maintenance orientation.

10. The single space parking meter of claim 9, wherein the second portion of the housing is locked to the first portion of the housing in the secured orientation.

11. The single space parking meter of claim 10, wherein a keyed lock is accessible through the first portion of the housing.

12. A single space parking meter comprising:
parking meter components providing metering functionality for a parking space; and
a housing comprising a first portion secured to a mounting structure located in the vicinity of the parking space and a second portion having one or more of the parking meter components coupled to an interior side of the second portion of the housing, the second portion at least partially separable from the first portion of the housing, wherein the first portion and the second portion can be arranged in:
a vertical maintenance position in which the second portion is secured to the first portion in a generally vertical orientation with at least a portion of the parking meter components accessible for performing maintenance; and
a horizontal maintenance position in which the second portion is secured to the first portion in a generally horizontal orientation with one or more of the parking meter components accessible for performing maintenance.
